(19) United States
(12) Patent Application Publication
(10) Pub. No.: US 2015/0212293 A1
(43) Pub. Date: Jul. 30, 2015

(54) ACTUATOR FOR COMPACT CAMERA

(71) Applicant: HYSONIC. CO., LTD., Ansab-si (KR)

(72) Inventors: Hyun Cheal Bang, Ansan-si (KR); Hyun Hee Sul, Ansan-si (KR)

(21) Appl. No.: 14/395,218

(22) PCT Filed: Aug. 12, 2013
(86) PCT No.: PCT/KR2013/007224

§ 371 Date: Oct. 17, 2014

(30) Foreign Application Priority Data
Oct. 15, 2012 (KR) 10-2012-0114258

(51) Int. Cl. G02B 13/00; H04N 5/225; G02B 27/64

(52) U.S. Cl. CPC G02B 13/0015; G02B 27/648; H04N 5/2254

(57) ABSTRACT

An actuator includes: a main body having a working space therein; a coil mounted to the main body; a blade in which a lens is mounted and inserted into and disposed in the working space; a magnet mounted to the blade and disposed to face the coil to form a magnetic field around the coil, for generating driving power upwards and downwards through an electromagnetic interaction; a wire an end of which is mounted to the main body and an opposite end of which is mounted to the blade, for supporting the blade such that the blade is vertically moved; a Hall sensor mounted to the main body, for measuring a deviation of a vertical position of the magnet with respect to the main body; and a controller for applying a current for correcting the position deviation of the magnet to the coil.

### TECHNICAL FIELD

The present invention relates to an actuator for a compact camera, and more particularly to an actuator for a compact camera which can correct a position deviation of a lens to accurately and precisely adjust a focus of the lens.

### BACKGROUND ART

In general, with the development of the technology of manufacturing mobile communication terminals including a digital camera or a camera module, compact and light camera modules are being provided.

In addition, as camera module packages for mobile phones have been recently equipped with high pixels and high functions, technologies are being rapidly developed to realize a performance similar to that of a high-end digital camera. In particular, tries to realize the auto-focusing technology to a mobile phone are being made in various ways.

Actuators allowing the auto-focusing technology largely include a voice coil actuator using a Lorentz force and a piezo actuator using a piezoelectric effect.

Korean Patent Application Publication No. 10-2008-0069095 discloses a voice coil actuator type camera actuator.

FIG. 1 is a perspective view of a camera actuator according to the related art. FIG. 2 is a sectional view of a camera actuator according to the related art.

As shown in FIGS. 1 and 2, the camera actuator 200 according to the related art largely includes a movable part and a fixed part.

The movable part includes a bobbin 220 fixing a lens 210, and a coil 260 integrally formed with the bobbin 220.

The fixed part includes a permanent magnet 250 for supplying a magnetic force to the coil 260, and a yoke in which the permanent magnet is installed.

The yoke includes an inner yoke 281 and an outer yoke 282 integrally formed with the inner yoke 281, and the yoke is fixed to a camera for a mobile phone (not shown).

In the camera actuator 200, a magnetic field is formed around the coil 260 by the permanent magnet 250, and if a current flows through the coil 260, a force is applied to the upper or lower side of the coil 260 by Fleming's left hand rule.

Then, the bobbin 220 and the lens 210 which are integral with the coil 260 are moved vertically.

Accordingly, wires 291 and 292 are installed in the bobbin 220 to give a restoring force to the movable part vertically moved by the coil 260.

However, the camera actuator 200 according to the related art may cause an abnormal operation such as tilting or decentering according to an error or an assembly tolerance of a component due to the unstable wires 291 and 292.

In addition, due to the self-weight of the movable part, the combination state of components, and a deviation of the wires, it is difficult to accurately adjust a focus of the lens as a position deviation is generated even if the same current is applied when the movable part is elevated.

### DISCLOSURE

### Technical Problem

The present invention has been made in an effort to solve the above-mentioned problems, and it is an object of the present invention to provide an actuator for a compact camera which can correcting a position deviation of a lens to accurately and precisely adjust a focus of the lens without distortion of an optical axis of the lens.

### Technical Solution

In accordance with an aspect of the present invention, there is provided an actuator for a compact camera, including: a main body having a working space therein; a coil mounted to the main body; a blade in which a lens is mounted and inserted into and disposed in the working space; a magnet mounted to the blade and disposed to face the coil to form a magnetic field around the coil, for generating driving power upwards and downwards through an electromagnetic interaction; a wire an end of which is mounted to the main body and an opposite end of which is mounted to the blade, for supporting the blade such that the blade is vertically moved; a Hall sensor mounted to the main body, for measuring a deviation of a vertical position of the magnet with respect to the main body; and a controller for applying a current for correcting the position deviation of the magnet to the coil according to information of the position deviation of the magnet with respect to the main body provided from the Hall sensor.

The main body includes: a base having the working space at an upper portion thereof; and a holder coupled to an upper portion of the base. Two or more wires are disposed in parallel to the base such that ends of the wires are mounted to the holder and opposite ends of the wires are mounted to opposite sides of the blade so that the wires support the blade upwards. A distance between a pair of wires disposed at the same height and mounted to opposite sides of the blade becomes gradually narrower as it goes from a side where the holder is disposed toward a side where the blade is disposed.

The actuator further includes a yoke mounted to the main body, for concentrating a magnetic field formed by the magnet on the coil. The coil is disposed between the magnet and the yoke.

The main body includes: a base having the working space at an upper portion thereof; and a holder vertically coupled to an upper portion of the base and to which one end of the wire is mounted. A mounting plate one end of which is mounted to an outer surface of the holder and bent to surround the blade such that an opposite end thereof is disposed outside the magnet. The Hall sensor is mounted to an inner surface of the opposite end of the mounting plate to face the magnet, the Hall sensor is wound about the Hall sensor and is mounted to an inner surface of the opposite end of the mounting plate to face the magnet, and the yoke is mounted to an outer surface of the opposite end of the mounting plate.

The magnet is horizontally polarized such that upper and lower sides of the magnet have the opposite polarities.

A filling recess in which the wire is inserted and disposed is formed in the main body to which one end of the wire is mounted, and an absorbing material surrounding the wire is filled in the filling recess.

An absorbing material is inserted and disposed between the main body and the blade.

A protruding piece forming the working space protrudes upwards from an upper portion of the base, a coupling part to which an opposite end of the wire is mounted protrudes from the blade, and the absorbing material is disposed between the protruding piece and the coupling part.

The cross-section of the wire is formed such that a longitudinal length corresponding to a direction in which the blade is moved vertically is shorter than a transverse length perpendicular to the longitudinal length.

The holder is preliminarily coupled to an upper portion of the base to be moved horizontally such that a position of the holder is adjusted and then is fixedly coupled to the base.

A coupling boss protrudes from one of the holder and the base and a coupling recess in the coupling boss is inserted and disposed is formed in the other of the holder and the base, and an inner diameter of the coupling recess is larger than a diameter of the coupling boss.

### Advantageous Effects

The actuator for a compact camera according to the present invention has the following effects.

A position deviation of a blade can be corrected such that a focus of a lens mounted to a blade can be precisely and accurately adjusted by measuring a vertical position deviation of a magnet by a Hall sensor, receiving vertical position deviation information of the magnet from the Hall sensor, applying a current to a coil by a controller, and adjusting a vertical position of a blade to which the magnet is mounted.

Further, as a distance between a pair of wires disposed at the same height and mounted to opposite sides of a blade becomes gradually narrower as it goes from a side where a holder is disposed toward a side where the blade is disposed, deflection of the wires in a lateral direction perpendicular to an optical axis direction of the lens can be prevented so that an abnormal operation such as tilting or decentering of the optical axis of the lens can be prevented by preventing lateral inclination or twisting of the blade during driving of the camera actuator.

Further, as a coil is disposed between a magnet and a yoke, emission of a magnetic field formed by the magnet to the outside of a camera actuator can be minimized and the magnetic field can be concentrated around the coil so that the blade can be vertically moved easily by an electromagnetic force.

In addition, as a wire is filled in a filling recess formed in a main body and an absorbing material is filled in the filling recess, settling time of the wire can be decreased by absorbing impacts and vibrations of the wire.

Furthermore, as the holder is coupled to an upper portion of the base to be horizontally moved, the holder can be horizontally moved such that the blade coupled to and supported by the holder can be moved together by a wire, and an optical axis of the lens and the center of an image sensor can coincide with each other by aligning the lens mounted to the blade and an initial position of the image sensor.

### DESCRIPTION OF DRAWINGS

FIG. 1 is a perspective view of a camera actuator according to the related art;

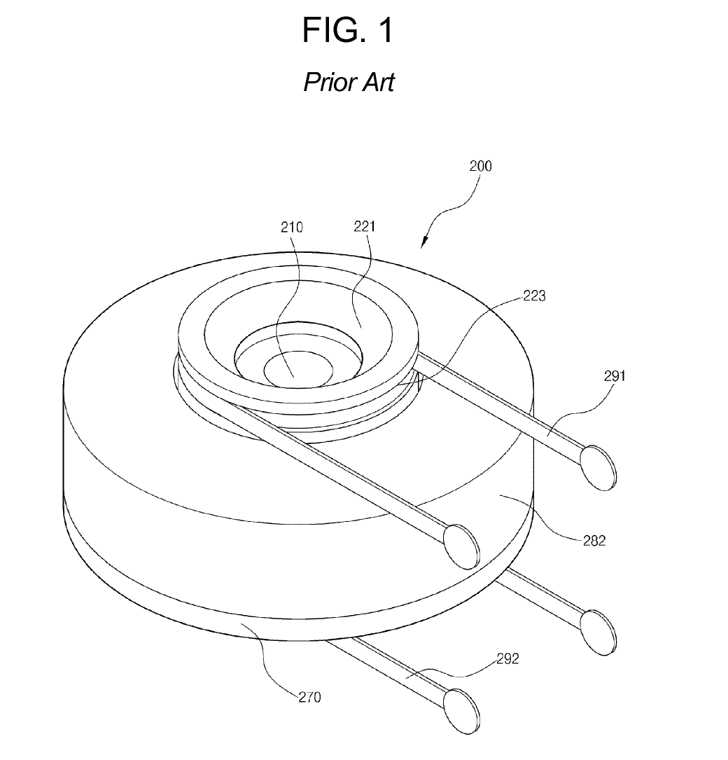

FIG. 2 is a sectional view of a camera actuator according to the related art;

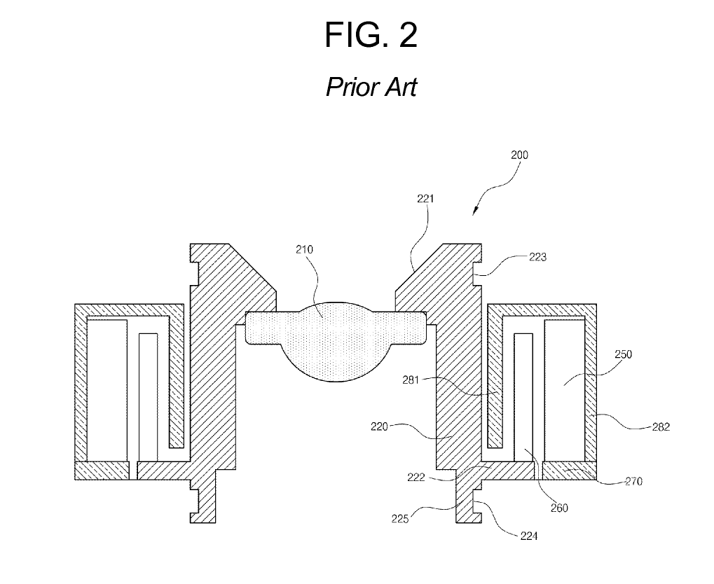

FIG. 3 is a perspective view of an actuator for a compact camera according to a first embodiment of the present invention;

FIG. 4 is an exploded perspective view of the actuator for a compact camera according to the first embodiment of the present invention;

FIG. 5 is a plan view of the actuator for a compact camera according to the first embodiment of the present invention;

FIG. 6 is a sectional view taken along line A-A of FIG. 3;

FIG. 7 is a perspective view of an actuator for a compact camera according to a second embodiment of the present invention; and

FIG. 8 is a sectional view taken along line B-B of FIG. 3.

### BEST MODE

### Mode for Invention

Hereinafter, exemplary embodiments of the present invention will be described in detail with reference to the accompanying drawings.

### First Embodiment

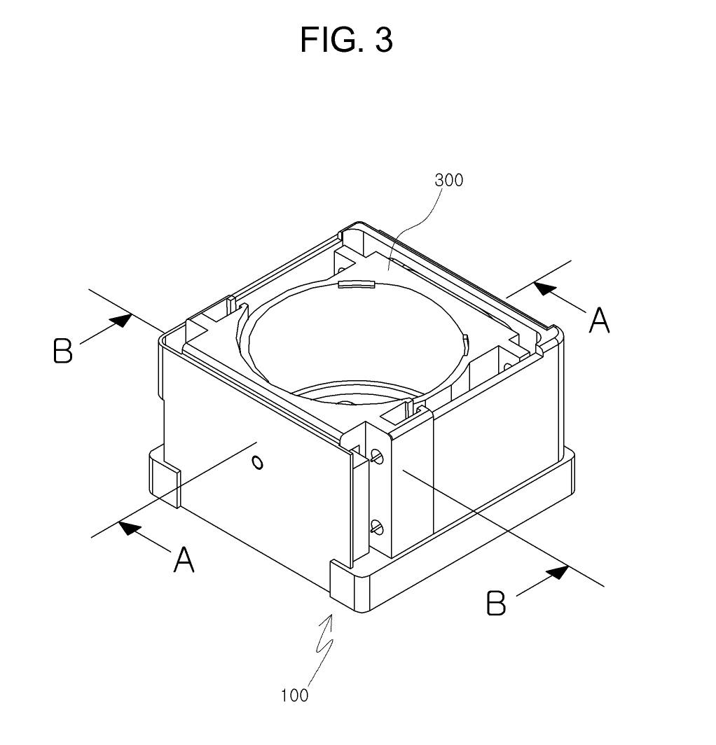

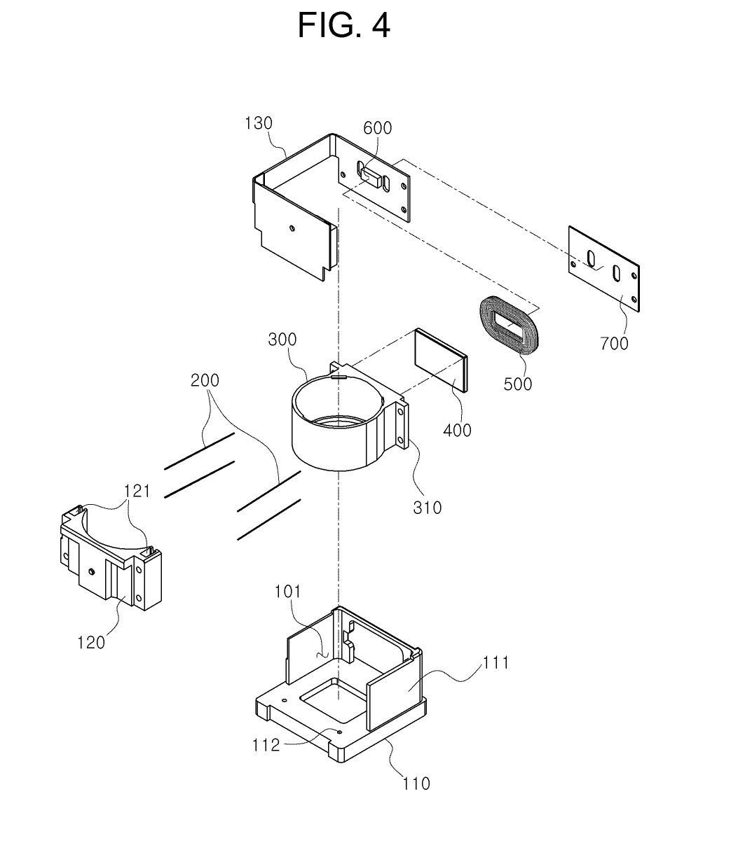

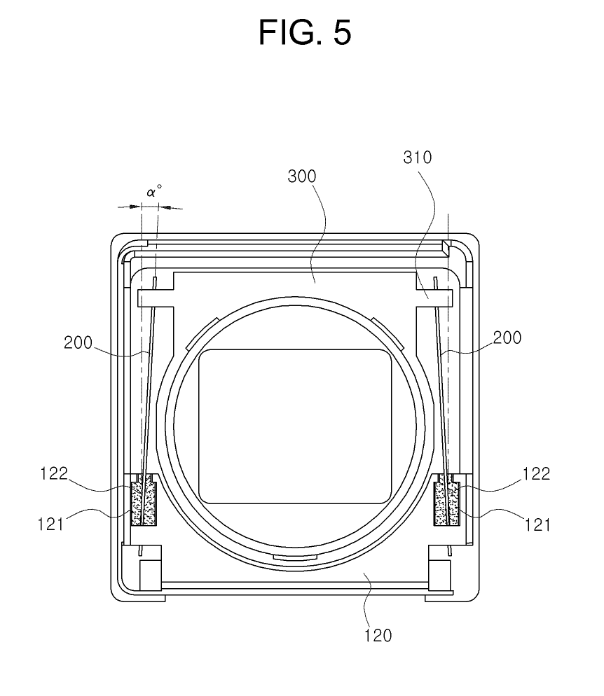

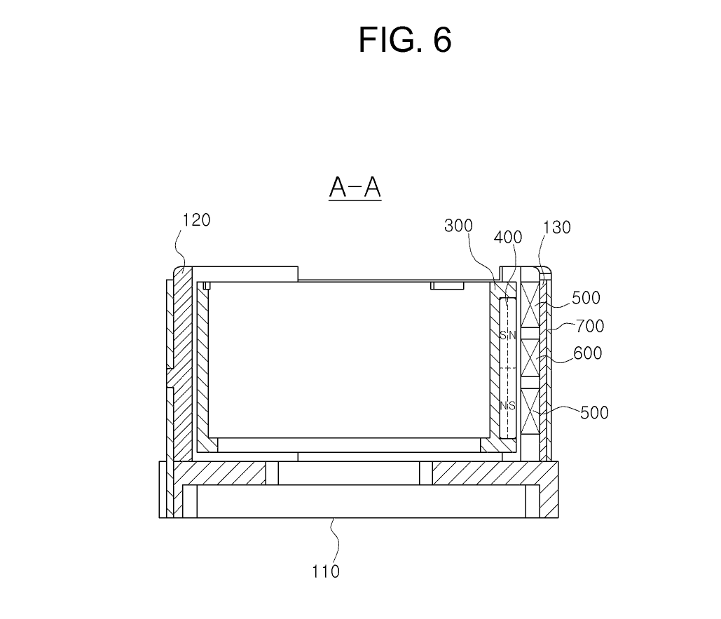

FIG. 3 is a perspective view for a compact camera according to a first embodiment of the present invention. FIG. 4 is an exploded perspective view of an actuator for a compact camera according to a second embodiment of the present invention. FIG. 5 is a plan view view of an actuator for a compact camera according to a third embodiment of the present invention. FIG. 6 is a sectional view taken along line A-A of FIG. 3.

As shown in FIGS. 3 to 6, an actuator for a compact camera according to the embodiments of the present invention includes a main body 100, a wire 200, a blade 300, a magnet 400, a coil 500, a Hall sensor 600, a yoke 700, and a controller (not shown).

As shown in FIGS. 3 and 4, the main body 100 has a working space 101 therein, and includes a base 110, a holder 120, and a mounting plate 130.

A protruding piece 111 protrudes from the base 110 to form the working space and the holder 120 is coupled to the base 110.

A coupling recess 112 is formed at an upper portion of the base 110.

As shown in FIG. 4, in the embodiment of the present invention, two coupling recesses are formed on an upper surface of the base 110 to which the holder 120 is coupled.

The base 110 is disposed at an upper portion of a camera image sensor.

The holder 120 is vertically coupled to an upper portion of the base 110, and one end of the wire 200 is fixedly mounted to the holder 120.

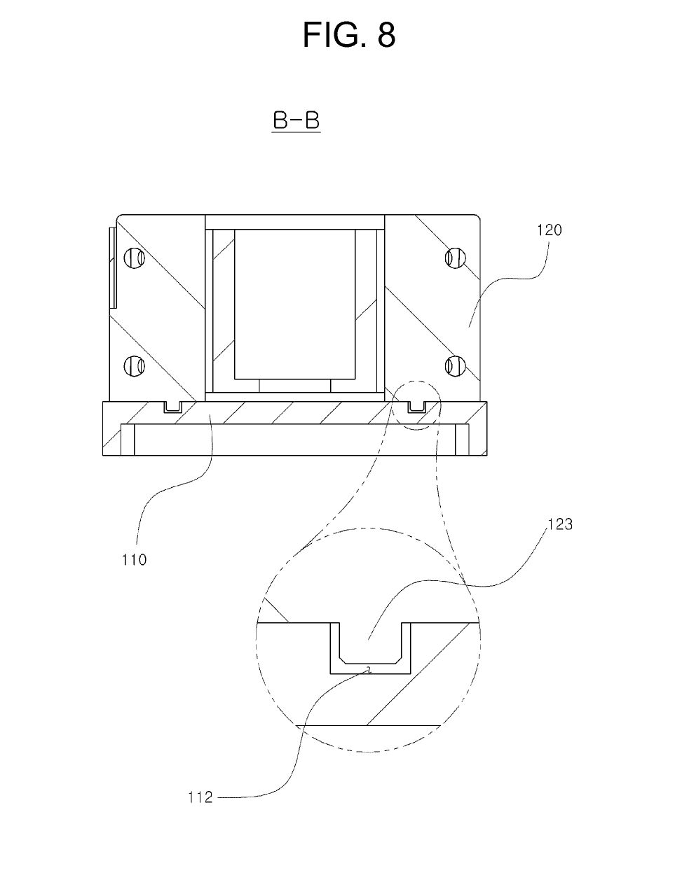

In detail, as shown in FIG. 8, coupling bosses 123 inserted into the coupling recesses 112 protrude from lower portions of the holder 120.

FIG. 8 is a sectional view taken along line B-B of FIG. 3, and shows a state in which the coupling bosses 123 are inserted into the coupling recesses 112 and the holder 120 is coupled to the base 110.

Because the inner diameters of the coupling recesses 112 are larger than the diameters of the coupling bosses 123, the coupling bosses 123 inserted into and disposed in the coupling recesses 112 may be moved horizontally within the coupling recesses 112.

Accordingly, if the coupling bosses 123 are inserted into the coupling recesses 112 such that the base 110 and the holder 120 are preliminarily coupled to each other and the holder 120 is horizontally moved while the coupling bosses 123 are inserted into the coupling recesses 112 during an assembly process, the blade 300 coupled to and supported by the holder 120 is moved together by the wire 200 so that the lens mounted to the blade 300 may be arranged at an initial location of the image sensor.

In this way, the lens and the initial location of the image sensor are arranged such that an optical axis of the lens and the center of the image sensor coincide with each other.

Thereafter, the holder 120 is fixed to the base 110.

The coupling recesses 112 and the coupling bosses 123, which have been described above, are not limited to the embodiment of the present invention, and the coupling recesses 112 may be formed at lower portions of the holder 120 and the coupling bosses 123 may be formed at upper portions of the base 110.

Filling recesses 121 are formed in the holder 120 to which one end of the wire 200 is mounted.

An absorbing material 122 surrounding one end of the wire 200 is filled in the filing recesses 121.

Upper or lower sides of the filling recesses 121 are opened to the outside, and after one end of the wire 200 is inserted into the filling recesses 121, the absorbing material 122 is applied and filled through the opened sides of the filling recesses 121.

In this way, because the absorbing material 122 is applied to the filling recesses 121 to surround the wire 200, settling time for stopping the wire 200 after the wire 200 is resiliently deformed can be decreased by absorbing an impact when the camera is shaken or the wire is deflected to drive the camera actuator.

One end of the mounting plate 130 is mounted to an outer surface of the holder 120, and an opposite end thereof is disposed outside the magnet 400 by bending the mounting plate 130 such that the mounting plate 130 surrounds the blade 300.

The mounting plate 130 is formed of a Flexible Printed Circuit Board (FPCB) such that the controller is mounted in the mounting plate 130, and one end of the mounting plate 130 is mounted to the holder 120 and the coil 500, the Hall sensor 600, and the yoke 700 are mounted to an opposite end of the mounting plate 30.

If necessary, the mounting plate 130 may not be formed of a circuit board, but a circuit board may be attached to a separate mounting plate 30.

One end of the wire 200 is mounted to the main body 100, and an opposite end thereof is mounted to the blade 300 to vertically support the blade 300.

That is, one end of the wire 200 is fixedly mounted to the holder 120 and inserted into and disposed in the filling recess 121 such that the blade 300 to which the opposite end of the wire 200 is fixedly mounted is moved in a vertical direction, which is an optical axis direction of the lens, while the wire 200 is resiliently deformed vertically.

The wire 200 is formed of a resilient metallic material and generates vibrations when an external impact is applied to the wire 200 or the camera actuator is driven to vertically move the wire 200, and then as described above, because the absorbing material 122 is filled in the filling recess 121 to surround the wire 200, vibrations and impact generated by the wire 200 are absorbed so that the settling time of the wire 200 is reduced.

Two or more wires 200 are disposed in parallel to the base 110.

In the embodiment of the present invention, four wires 200 are mounted to upper and lower portions of opposite sides of the blade 300 to support the blade 300 upwards.

As shown in FIG. 5, a distance between a pair of wires 200 disposed at the same height and mounted to opposite sides of the blade 300 becomes narrower as it goes from a side where the holder 120 is disposed toward a side where the blade 300 is disposed.

Accordingly, because the wire 200 is easily resiliently deformed in a vertical direction, which is an optical axis direction of the lens and cannot be easily deformed laterally leftwards and rightwards, lateral inclination or torsion of the blade 300 can be prevented during driving of the camera actuator, so that an abnormal operation such as tilting or decentering of the optical axis of the lens can be prevented.

In detail, although a mutual inclination angle of the wires 200 is preferably 3° (α) in consideration of a structure and a driving condition of the camera actuator according to the embodiment of the present invention, the present invention is not limited thereto and the mutual inclination angle of the wires 200 may be properly adjusted when the wires 200 are manufactured.

The above-described wires 200 may have circular or other various sectional shapes.

In general, the wires 200 have a circular sectional shape, but the wires 200 may be formed such that a longitudinal length of the cross-section of the wires 200, along which the blade 300 is vertically moved, is shorter than a transverse length of the cross-section of the wires 200, which is perpendicular to the longitudinal length of the cross-section of the wires 200.

In this way, as the longitudinal length of the cross-section of the wires 200 is shorter than the transverse length of the cross-section of the wires 200, the wires 200 may be easily deformed vertically and the wires 200 can be prevented from being deformed laterally.

Accordingly, as described above, due to an inclined structure of the wires 200 and the sectional shape of the wires 200, an effect of preventing lateral inclination or torsion of the blade 300 caused by lateral deformation of the wires 200 can be further improved.

The above-described wires 200 can show an effect of restraining lateral deformation of the wires 200 only with the inclined structure of the wires 200 regardless of the sectional shape of the wires 200.

A lens is mounted within the blade 300, and the blade 300 is inserted into and disposed in the working space 101.

As described above, the blade 300 is vertically supported by the wires 200 to adjust a focus of the lens while being vertically moved.

In detail, coupling parts 310 protrude from opposite ends of the blade 300, and the opposite ends of the wires 200 are fixedly mounted by the coupling parts 310.

As shown in FIG. 6, the magnet 400 is mounted to an outer surface of the blade 300 and is disposed to face the coil 500 to form a magnetic field around the coil 500.

If a current is applied to the coil 500, it generates driving power in a vertical direction due to an electromagnetic interaction with the coil 500.

Because the magnet 400 is mounted to the blade 300, the blade 300 is vertically moved together by an electromagnetic force applied to the magnet 400 such that the wires 200 are resiliently moved vertically.

Then, as described above, the pair of wires 200 are disposed not in parallel but at an inclination angle, they may be resiliently deformed easily in a vertical direction but may be resiliently deformed laterally so that the blade 300 can be prevented from being inclined laterally or twisted.

In detail, the magnet 400 is polarized in a horizontal direction in which the coil 500 is disposed, and the polarities of the upper and lower sides of the magnet 400 are opposite to each other.

Accordingly, a current is applied to the coil 500 around which a magnetic field is formed by the magnet 400, the magnet 400 receives an electromagnetic force upwards or downwards according to the direction of the current applied to the coil 500 by an electromagnetic interaction of the magnet 400 and the coil 500.

Driving power is generated by the electromagnetic force applied to the magnet 400 to elevate the blade 300 supported by the wire 200, and as the blade 300 is elevated, a focus of the lens is adjusted while the wire 200 is resiliently deformed.

The coil 500 is fixedly mounted to the main body 100.

That is, the coil 500 is fixedly mounted to an inner surface of an opposite end of the mounting plate 130 to face the magnet 400.

The coil 500 is wound about the Hall sensor 600, and is disposed between the magnet 400 and the yoke 700.

As described above, the coil 500 is spaced apart from the magnet 400 so as to be adjacent to the magnet 400 and is influenced by the magnetic field generated by the magnet 400, and if a current is applied to the coil 500, driving power is generated by the electromagnetic force between the coil 500 and the magnet 400.

Then, because the coil 500 is fixedly mounted to the mounting plate 130 and the magnet 400 is mounted to the blade 300 and supported by the wire 200 to be vertically moved, the focus of the lens is adjusted while the blade 300 is vertically moved.

The yoke 700 is mounted to the main body 100 to concentrate a magnetic field formed by the magnet 400 on the coil 500.

In detail, the yoke 700 has a tetragonal shape and is mounted to an outer surface of the opposite end of the mounting plate 130.

The yoke 700 is adapted to intensively distribute the magnetic field formed by the magnet 400 around the coil 500 while minimizing the magnetic field from being discharged to the outside of the actuator, and may not be included in the camera actuator as a component element of the camera actuator.

The Hall sensor 600 is fixedly mounted to the main body 100 to measure a vertical position deviation of the magnet 400 with respect to the main body 100.

In detail, the Hall sensor 60 is mounted to an inner surface of the opposite end of the mounting plate 130 and faces the magnet 400, and detects a change in distribution of the magnetic field of the magnet 400, designates the position deviation of the magnet 400 as a code value, and transmits the code value to the controller.

The controller is mounted to the main body 100, and receives information on position deviation of the magnet 400 with respect to the main body 100 and applies a current to the coil 500 to correct the position deviation of the blade 300 to which the magnet 400 is mounted.

That is, the controller is mounted to the mounting plate 130 formed of a circuit board, and receives a code value according to the position deviation of the magnet 400 from the

Hall sensor 600 and applies a current to the coil 500 to correct the position deviation of the blade 300 by vertically moving the magnet 400 and the blade 300 to which the magnet 400 is mounted.

In this way, as the Hall sensor 600 transmits the position deviation information of the magnet 400 to the controller and vertically moves the blade 300 according to the position deviation information of the magnet 400 to correct the position deviation, the focus of the lens mounted to the blade 300 can be precisely and accurately adjusted.

As described above, the vertical direction is an optical axis direction of the lens and a vertical direction and a lateral direction are relatively determined according to the optical axis direction of the lens.

Hereinafter, a method of operating the actuator for a compact camera having the above-described configuration will be described.

Ends of the wires 200 is mounted to the holder 120 in parallel to the base 110, and the blade 300 mounted to opposite ends of the wires 200 are supported to be vertically moved.

Then, a deviation is generated in the position of the blade 300 by the self-weights of the wires 200 and the blade 300 according to the posture of the camera actuator.

That is, the wires 200 are deflected by the gravitational force according to a posture in which the user grips a camera to use the camera so that a deviation is generated in the position of the blade 300.

Further, because due to a magnetic hysteresis, displacements of the blade 300 due to a vertical movement of the blade 300 are different when a current is applied to the coil 500 such that an electromagnetic force is applied between the magnet 400 and the coil 500, and when a current to the coil 500 is blocked such that an electromagnetic force is not applied between the magnet 400 and the coil 500, a deviation is generated in the position of the blade 300 even if the same current is applied to the coil 500.

In addition, a deviation may be generated in the displacement of the blade 300 according to the combination shape of the components or a difference between the properties of the wires 200.

Accordingly, the Hall sensor 600 measures a deviation of a vertical position of the blade 300 to which the magnet 400 is mounted to forward the deviation to the controller, and the controller adjusts an amount of currents applied to the coil 500 according to the position deviation signal of the blade 300 to vertically move the blade 300.

In this way, the focus of the lens mounted to the blade 300 can be precisely and accurately adjusted by repeatedly measuring and correcting the position deviation of the blade 300 using the Hall sensor 600 and the controller.

As described above, when the focus of the lens is adjusted while the blade 300 is vertically moved, the wires 200 supporting the blade 300 upwards are resiliently deformed vertically.

Because the pair of wires 200 disposed at the same height are disposed to be inclined with respect to each other, lateral deflections of the wires 200 are limited.

Accordingly, an abnormal operation such as tilting or decentering of the optical axis of the lens can be prevented by preventing the blade 300 from being inclined laterally or twisted.

### Second Embodiment

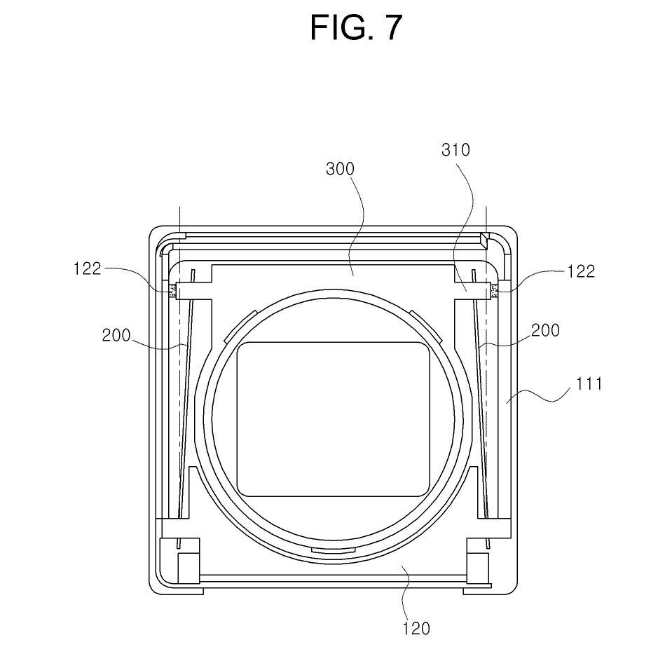

FIG. 7 is a perspective view of an actuator for a compact camera according to a second embodiment of the present invention.

The second embodiment of the present invention is different from the first embodiment of the present invention in their absorbing materials, and their difference will be intensively described.

An actuator for a compact camera according to the second embodiment of the present invention includes a main body 100, a wire 200, a blade 300, a magnet 400, a coil 500, a Hall sensor 600, a yoke 700, and a controller (not shown).

The main body 100 includes a base 110, a holder 120, and a mounting plate 130.

The base 110 and the mounting plate 130 are the same as those of the first embodiment, and a filling recess 121 is not formed in the holder 120.

Accordingly, the absorbing material 122 is not filled in the filling recess 121 and is inserted and disposed between the main body 100 and the blade 300.

In detail, as shown in FIG. 7, the absorbing material 122 is disposed between the protruding piece 111 and the coupling parts 310.

The absorbing material 122 is fixedly mounted to the protruding piece 111 and the coupling parts 310, and is formed of a resilient material such that the shape thereof is deformed when the blade 300 from which the coupling parts 310 protrude is vertically moved.

Accordingly, the absorbing material 122 absorbs impacts applied to the wires 200 or vibrations generated by the wires 200 while being resiliently deformed when the blade 300 is vertically moved, decreasing settling time of the wires 200.

Although not shown, the absorbing material 121 may be disposed between the magnet 400 mounted to the blade 300 and the coil 500 mounted to the mounting plate 130 and may be fixedly mounted to the magnet 400 and the coil 500.

In addition, the absorbing material 121 is disposed between the main body 100 or the blade 300 vertically moved with respect to the main body 100 to absorb impacts and vibrations of the wires 300.

The other items of the second embodiment are the same as those of the first embodiment, and a detailed description thereof will be described.

The actuator for a compact camera according to the present invention is not limited to the above-described embodiment, but may be variously deformed without departing from the spirit of the present invention.

1. An actuator for a compact camera, comprising:
a main body having a working space therein;
a coil mounted to the main body;
a blade in which a lens is mounted and inserted into and disposed in the working space;
a magnet mounted to the blade and disposed to face the coil to form a magnetic field around the coil, for generating driving power upwards and downwards through an electromagnetic interaction;
a wire an end of which is mounted to the main body and an opposite end of which is mounted to the blade, for supporting the blade such that the blade is vertically moved;
a Hall sensor mounted to the main body, for measuring a deviation of a vertical position of the magnet with respect to the main body; and
a controller for applying a current for correcting the position deviation of the magnet to the coil according to information of the position deviation of the magnet with respect to the main body provided from the Hall sensor.

2. The actuator of claim 1, wherein the main body comprises:
a base having the working space at an upper portion thereof; and
a holder coupled to an upper portion of the base,
wherein two or more wires are disposed in parallel to the base such that ends of the wires are mounted to the holder and opposite ends of the wires are mounted to opposite sides of the blade so that the wires support the blade upwards, and
a distance between a pair of wires disposed at the same height and mounted to opposite sides of the blade becomes gradually narrower as it goes from a side where the holder is disposed toward a side where the blade is disposed.

3. The actuator of claim 1, further comprising a yoke mounted to the main body, for concentrating a magnetic field formed by the magnet on the coil,
wherein the coil is disposed between the magnet and the yoke.

4. The actuator of claim 3, wherein the main body comprises:
a base having the working space at an upper portion thereof; and
a holder vertically coupled to an upper portion of the base and to which one end of the wire is mounted; and
a mounting plate one end of which is mounted to an outer surface of the holder and bent to surround the blade such that an opposite end thereof is disposed outside the magnet,
wherein the Hall sensor is mounted to an inner surface of the opposite end of the mounting plate to face the magnet, the Hall sensor is wound about the Hall sensor and is mounted to an inner surface of the opposite end of the mounting plate to face the magnet, and the yoke is mounted to an outer surface of the opposite end of the mounting plate.

5. The actuator of claim 1, wherein the magnet is horizontally polarized such that upper and lower sides of the magnet have the opposite polarities.

6. The actuator of claim 1, wherein a filling recess in which the wire is inserted and disposed is formed in the main body to which one end of the wire is mounted, and an absorbing material surrounding the wire is filled in the filling recess.

7. The actuator of claim 2, wherein an absorbing material is inserted and disposed between the main body and the blade.

8. The actuator of claim 7, wherein a protruding piece forming the working space protrudes upwards from an upper portion of the base, a coupling part to which an opposite end of the wire is mounted protrudes from the blade, and the absorbing material is disposed between the protruding piece and the coupling part.

9. The actuator of claim 1, wherein the cross-section of the wire is formed such that a longitudinal length corresponding to a direction in which the blade is moved vertically is shorter than a transverse length perpendicular to the longitudinal length.

10. The actuator of claim 2, wherein the holder is preliminarily coupled to an upper portion of the base to be moved horizontally such that a position of the holder is adjusted and then is fixedly coupled to the base.

11. The actuator of claim 10, wherein a coupling boss protrudes from one of the holder and the base and a coupling recess in the coupling boss is inserted and disposed is formed in the other of the holder and the base, and an inner diameter of the coupling recess is larger than a diameter of the coupling boss.

12. The actuator of claim 4, wherein an absorbing material is inserted and disposed between the main body and the blade.

13. The actuator of claim 12, wherein a protruding piece forming the working space protrudes upwards from an upper portion of the base, a coupling part to which an opposite end of the wire is mounted protrudes from the blade, and the absorbing material is disposed between the protruding piece and the coupling part.

14. The actuator of claim 2, wherein the cross-section of the wire is formed such that a longitudinal length corresponding to a direction in which the blade is moved vertically is shorter than a transverse length perpendicular to the longitudinal length.
